(19) United States
(12) Patent Application Publication
(10) Pub. No.: US 2008/0260952 A1
(43) Pub. Date: Oct. 23, 2008

(54) Ceramic Coating

(75) Inventors: Ping Xiao, Cheshire (GB); Xin Wang, Cheshire (GB)

Correspondence Address: BARLOW, JOSEPHS & HOLMES, LTD., 101 DYER STREET, 5TH FLOOR, PROVIDENCE, RI, 02903, US

(73) Assignee: THE UNIVERSITY OF MANCHESTER, Manchester (GB)

(21) Appl. No.: 10/597,356

(22) PCT Filed: Jan. 21, 2005
(86) PCT No.: PCT/GB2005/000224

§ 371 Date: Jul. 10, 2008

(30) Foreign Application Priority Data
Jan. 22, 2004 (GB) 0401379.3
Apr. 23, 2004 (GB) 0409078.3
Oct. 4, 2004 (GB) 0421985.3

(51) Int. Cl. B05D 3/02; C04B 35/01; C04B 35/44; C04B 35/447; C04B 35/58

(52) U.S. Cl. 427/373; 427/376.3; 501/96.3; 501/103; 501/127; 501/132; 501/126; 501/94

(57) ABSTRACT

The present invention relates to a green ceramic coating composition, the composition comprises nano-sized particles dispersed within a carrier medium together with preformed particles. The composition optionally comprises an infiltration medium.

The present invention relates to a ceramic coating and a method of preparing and applying said coating.

Ceramic coatings are typically applied to substrates to provide protection, in particular thermal protection to the underlying substrate. These substrates tend to be metallic.

One desirable method of producing a ceramic coating is by a slurry process. A slurry process involves preparing either an aqueous or non-aqueous slurry, applying the slurry to the substrate to form a layer or multi layer coating. The coating is then heat treated or sintered in order that a ceramic coating is produced. The coating prior to sintering is referred to as a green coating.

Many ceramic coatings comprise zirconia. However, zirconia is not generally suitable for application to a metallic substrate by a slurry process.

Typical zirconia coatings comprise crystallite of a conventional size typically in the range from about 1 to about 10 microns. In order to produce a ceramic coating these conventional sized zirconias require sintering temperatures of around 1400° C., clearly the metallic substrate cannot withstand such a temperature. Furthermore, the green coating tends to shrink during drying and sintering, causing an uncompromising dimensional mismatch between the coating and the substrate and thereby leading to the coating cracking and/or spalling.

Therefore, no crystalline ceramic coatings of a thickness greater than 100 μm have been produced by a slurry method.

However, ceramic coatings of a thickness greater than 100 μm are routinely utilised as a thermal barrier coating (TBC) in gas turbine engines.

Typically, a thermal barrier coating system comprises of yttria stabilised zirconia (YSZ) coat which adheres to the substrate via a layer of Al₂O₃ which is present on the surface of the substrate.

However, the use of these thermal barrier coatings is limited by their long-term durability.

Studies have shown that it is essential for TBC's to have a low elastic modulus in the plane of the coating to minimise the development of thermal expansion mismatch stresses and a low thermal conductivity perpendicular to the coating to minimise the heat transport through the coating to the underlying substrate. In order to address this, attempts have been made to control the porosity of the coatings by way of modifying the method of application of TBC's.

Thermal barrier coatings are currently applied by thermal spraying and electron beam physical vapour deposition (EPPVD).

However, whilst these techniques allow variation in the porosity of the coating they are expensive and require high capital investment and high operation cost.

Furthermore, both are so-called light-on-sight techniques. That is, techniques that are only suitable for the application of TBC's to visible areas of a substrate and as such it is impossible to deposit coating material on inner surfaces of deep holes and other hard to reach places.

In an attempt to address the aforesaid problems, researchers have turned to nano-size technology. The past decade has seen enormous investment in nano particles and nano-structure technologies. Nano-size technology not only delivers unusual properties and performance of components, but it also provides opportunities to revolutionise material processing techniques.

As mentioned previously conventional size crystalline zirconias are sintered at temperatures around 1400° C. Clearly, it is not possible to sinter such coatings whilst they are in contact with a metallic substrate as the substrate cannot withstand such temperatures.

The use of nano-size zirconias enables the sintering temperature to be reduced to around 975° C., However, this temperature is still too high for some metallic substrates.

Therefore, it is highly desirable to develop a coating and a method for its application which enables ceramic coatings to be sintered at a low temperature when in direct contact with a metallic substrate.

Such a system would reduce the cost of coating a metallic substrate, and offer more flexibility in that a coating could be applied to components with complex geometries.

According to the first aspect of the present invention there is provided a green ceramic coating composition comprising nano-sized particles dispersed within a carrier medium together with pre-formed particles.

According to the second aspect of the present invention there is provided a method for producing a ceramic coating upon a substrate comprising the following steps: preparing a nano-suspension containing nano-sized ceramic particles, preparing pre-formed particles, concentrating the nano-suspension to form a nano-slurry, mixing the preformed particles with the nano-slurry, applying the aforesaid mixture to the substrate, and heat treating the system such that the aforesaid particles become sintered thus producing a ceramic coating.

As referred to herein ‘carrier medium’ is intended to refer to a carrier medium for the ceramic particles. The particles are insoluble in the carrier medium.

Advantageously, the composition of the present invention can be used to produce a ceramic coating which does not crack or spall during the drying and sintering procedures. Significantly, the ceramic coating produced from the composition of the present invention comprises a crystalline nano-structure. Moreover, the composition of the present invention can be used to produce a coating having a thickness of up to 500 μm. This thickness may be achieved by the application of one or more layers of the composition of the present invention.

Furthermore, the method of the present invention is a non-light-of-sight technique such that all areas, including non-visible areas, of a substrate having a complex geometry may be coated.

A significant advantage of the present invention is that the combination of pre-formed particles with nano-size particles enables the coating composition to be sintered at a lower temperature which a metallic substrate can withstand. This is thought to arise as a result of the lower temperature binding effect of nano-sized particles.

A further advantage of the present invention is that the large pore structure and nano-sized grain structure gives rise to a coating has a low thermal conductivity such that the underlying metallic substrate is protected from heat.

Due to the use of a combination of pre-formed particles and nano-sized particles the morphology and distribution of porosity of the coating can be specifically tailored having regard for the application of the coated substrate.

The substrate of the present invention is any metallic substrate and its choice is limited only by the temperature of the method described herein. Suitable examples include Fecralloy, titanium alloys, aluminium alloys, stainless steel, inconel, Hastelloy, Monel alloy, Mumetal, and Platinum Aluminide.

Nano-sized particles can be synthesised using various techniques, such as chemical precipitation, sol-gel, hydrothermal synthesis, chemical vapour condensation, inert gas condensation, etc.

A nano-suspension can be prepared either by dispersing nano-sized particles within a carrier medium or applying wet chemical techniques, e.g. hydrothermal methods, which produce a suspension system directly without the necessity of dispersion.

Preferably the size of the nano-sized particles is less than 200 nm and more preferably less than 100 nm. Advantageously, this smaller particle size provides a better binding effect such that a lower sintering temperature can be utilised to achieve a cohesive coating. Therefore, the nano-sized particles of the present invention preferably have a narrow particle size distribution, typically in the range from 10 nm to 100 nm.

The carrier medium of the present invention is preferably water or a polar organic carrier medium, for example ethanol and isopropyl acetate (IPA).

The nano-sized particles are dispersed in the carrier medium such that a nano-suspension is afforded. As referred to herein a nano-suspension is a system whereby the nano-sized particles have a low solid loading, of typically less 10 wt %. A nano-slurry as referred to herein is a system whereby the nano-sized particles have a higher solid loading, typically greater than 20 wt %.

Suitable nano-sized particles may be derived from any of the following species which may be used alone or in combination; oxides, borides, silicides, phosphates, silicates, sulfides of any of the following species boron, aluminium, silicon, titanium, zirconium, hafnium, vanadium, niobium, tantalum, chromium, molybdenum, tungsten, lanthanum, yttrium, iron, cobalt and nickel. Particularly preferred examples of suitable nano-sized particles are zirconias, alumina, magnesia, titania, aluminium phosphate, zirconium silicate etc.

An important aspect of the present invention is the preparation of the pre-formed particles. Typically these particles have a particle size ranging from 5 μm to 300 μm and preferably from 10 μm to 150 μm. The nano-structure of the pre-formed particles may comprise crystallites in the order of 100 to 200 nm in size.

Preferably the preformed particles have a variety of different shapes and these particles may be derived from any suitable ceramic material. The pre-formed particles comprise a crystalline nano-structure.

The pre-formed particles may be such as to form a framework wherein at least some of the pre-formed particles contact each other. The extent of the framework depends upon the loading of the pre-formed particles. Advantageously, this feature provides strength to the coating of the present invention.

The pre-formed particles can be prepared using colloidal processing. This approach minimises defects formed by dry powder methods.

The pre-formed particles are typically prepared from a nano-suspension or nano-slurry of a suitable ceramic material by known methods such as electrophoretic deposition (EPD), dip coating, blade coating, spray drying and air drying.

Suitable ceramic materials which may used alone or in combination include those derived from oxides, borides, suicides, silicates, phosphates, sulfides of any of the following species boron, aluminium, silicon, titanium, zirconium, hafnium, vanadium, niobium, tantalum, chromium, molybdenum, tungsten, lanthanum, yttrium, iron, cobalt and nickel.

In a preferred embodiment of the method of the present invention the pre-formed particles are prepared by air-drying. A concentrated nano-slurry is allowed to dry in air at room temperature to form a solid compact. The solid compact is then crushed and ground. The ground material is then classified by way of a sieve. The ensuing pre-formed particles are of irregular shape, but are nevertheless broadly equiaxed.

In a further preferred embodiment of the method of the present invention the pre-formed particles are prepared by dip coating a nano-slurry on a substrate, followed by drying and peeling ensuing dried coating from the substrate. The peeled coating is crushed and ground and sieved in order to size classify the pre-formed particles.

In a particularly preferred embodiment of the method of the present invention the pre-formed particles are prepared by a combination of EPD and dip coating. This combination produces pre-formed particles having a plate-like physical form or small hollow tubes.

As varying the geometries of the pre-formed particles results in ceramic coatings having different microstructures and therefore different mechanical and thermal properties the choice of method for preparing the pre-formed particles can be used to influence the properties of the ceramic coating. For example, the thickness and aspect ratio of the plate-like particles can be adjusted by varying the slurry/suspension concentration, deposition time and deposition rate The present invention adopts a ‘bricks and mortar’ approach whereby the pre-formed particles are the ‘bricks’ and the slurry/suspension of nano-sized particles is the ‘mortar’.

A key step in the method of the present invention is the concentration of the nano-suspension to a nano-slurry with a desired solid loading. The nano-slurry tends to be in the form of a paste. The nano-suspension is preferably concentrated by way of freeze drying or heat drying in either air or vacuum.

The solid loading of the nano-slurry is preferably 20 to 60 wt %.

The ratio of the pre-formed particles to the nano-sized particles is in the range from 1:5 to 1:1 and preferably is 2:5 on a dry weight basis. Once concentrated, the paste is preferably stored in a sealed container in order that the paste does not dry out prematurely.

In order to aid application of the paste to the substrate and change the rheology of the paste any of the following may be added to the paste either alone or in combination; water, at least one polar dispersing medium such as ethanol and at least one polymeric surfactant/binder. Suitable polymeric surfactants/binders include poly-methacrylic acid (PMAA), poly-methylmethacrylate (PMMA), polyvinyl alcohol and methyl cellulose. Such polymeric surfactants/binders may be added to the paste in quantities up to about 5% w/w. The use of pastes having differently shaped preformed particles enables the pore architecture of the coatings to be manipulated. Such manipulation leads to distinctive thermal conductivity of the coatings. For example the use of plate-like pre-formed particles produced by EPD gives rise to a coating having a parallel pore structure and a relatively lower thermal conductivity. In contrast to this, the use of pre-formed particles with irregular shapes gives rise to a coating having a random pore structure and therefore a relatively higher thermal conductivity. The coatings of the present invention may have a thermal conductivity less than 1.0 w/m° C. and a porosity of more than 30 vol %. Typical plasma sprayed TBC's have been found to have a thermal conductivity of 1.22 w/m° C.

It has long been thought that the relatively low thermal conductivity of TBC's produced by PS and EBPVD techniques is due to the meta-stable tetragonal phase of zirconia present in the coating. However, the coatings of the present invention comprise only stable phases i.e. tetragonal and cubic phases. Thus, the coatings have no meta-stable phase, but still have a lower thermal conductivity than plasma sprayed coatings.

The coating composition of the present invention may be used to provide a multi-layered ceramic coating. Furthermore, each coat may comprise pre-formed particles having different architecture. For example, a paste comprising pre-formed particles having a plate like structure may be applied to a substrate and following heat treatment of that paste a second paste comprising irregularly shaped pre-formed particles may be applied thereto and heat treated

The green coating of the method of the present invention may be heat treated at any temperature in the range from 300 to 1200° C. However, heat treatment at 500° C. produces a ceramic coating which exhibits good strength and adhesion.

In order to increase the coating integrity and improve the coating/substrate adhesion, the coating is preferably infiltrated with an infiltration media after its heat treatment.

The infiltration media may be a suspension or a slurry.

Advantageously, this infiltration modifies the porosity of the coating and increases the inter-particle connectivity between the pre-formed particles of the coating.

The infiltration process preferably takes place in a pressure chamber at a pressure preferably greater than 1 MPa. However, prior to infiltration the chamber is vacuum-pumped in order to eliminate air and/or absorbed gas species from the pores of the green coating.

The infiltration media may contain exclusively nano-particles or a mixture or nano-particles and conventional fine powders dispersed in water, acetone, acetylacetone or other similar polar carrier medium. The solid loading of the infiltration suspension or slurry is preferably in the range from 5 to 80 wt %.

In addition to infiltration with the media referred to herein, the coating may also be infiltrated with other infiltration media. The choice of the infiltration media is determined by the desired properties of the final product. Suitable examples of infiltration media include, but are not limited to, any of the following either alone or in combination molten metals, such as molten aluminium, molten magnesium; molten salts, such as molten silicates and molten borates; metallic particles dispersed within a carrier medium, such as aluminium/alcohol suspension; polymeric materials, such as polyurethane, epoxy resin, ethylene copolymers, cyanoacrylates; and inorganic binders, such as aluminium phosphate/phosphate acid mixture.

The infiltration media may also be introduced into green ceramic coatings in addition or in the alternative to the nano-suspension/slurry as hereinbefore described thereby forming a composite coating material.

Thus, according to a further aspect of the present invention there is provided a green composite coating material comprising pre-formed particles dispersed within a carrier medium together with an infiltration media and/or nano-sized particles.

According to a further aspect of the present invention there is provided a method for producing a composite coating upon a substrate comprising the steps of: preparing pre-formed particles, preparing an infiltration medium, mixing together said particles and said medium, optionally adding to the mixture a nano-slurry or suspension, applying the aforesaid mixture to the substrate, and heat treating the system such that the aforesaid particles become sintered/set thus producing a composite coating.

The composite coating may be infiltrated in order to manipulate the porosity characteristics. Suitable infiltration media are described above.

According to a further aspect of the present invention there is provided a method of infiltrating a composite coating comprising the steps of: preparing a substrate having a composite coating as hereinbefore described, applying to the said coating an infiltration medium and/or nano-slurry/suspension, and heat treating the aforesaid infiltrated coating.

Advantageously, the use of an infiltration medium enables the initial green coating to be heat treated at a lower temperature than similar coatings which lack an infiltration medium. Therefore, this allows the use of metallic substrates, such as titanium alloys and aluminium alloys, magnesium alloys, which have been unsuitable for the applications described herein due to their low melting point. In any event, the infiltration process has been found to contribute to the mechanical strength of the coating.

Once infiltrated, the coating is then dried and heat treated at a temperature in the range from 300 to 1200° C., either in a vacuum or in air.

The infiltration process and subsequent heat treatment may be repeated until the desired density and architecture are achieved.

According to a further aspect of the present invention there is provided a method for producing a ceramic/metal composite coating upon a substrate comprising the steps of: preparing pre-formed particles, preparing an nano-slurry, mixing together said particles and said slurry, applying the aforesaid mixture to the substrate, and heat treating the system to produce a partially sintered ceramic porous coating; filling the pores and voids in aforesaid ceramic porous coating by employing electrochemical plating and/or electroless deposition with metallic materials, thus forming a ceramic/metal composite coating.

Suitable metallic materials that may be incorporated in the ceramic/metal composite coating by electrochemical plating and/or electroless deposition may be a pure metal or as an alloy of following elements: iron, cobalt and nickel, molybdenum, tungsten, lanthanum, yttrium, vanadium, niobium, tantalum, chromium, boron, aluminium, silicon, titanium, zirconium, hafnium.

In order that the present invention be more readily understood the present invention will now be described by way of example only and with reference to the following examples and drawings in which:

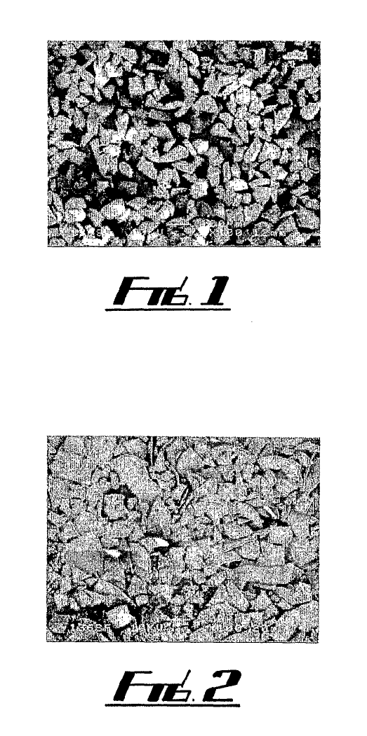

FIG. 1 shows a representation of irregular pre-formed particles prepared in accordance with one embodiment of the present invention;

FIG. 2 shows a representation of plate-like preformed particles prepared in accordance with one embodiment of the present invention;

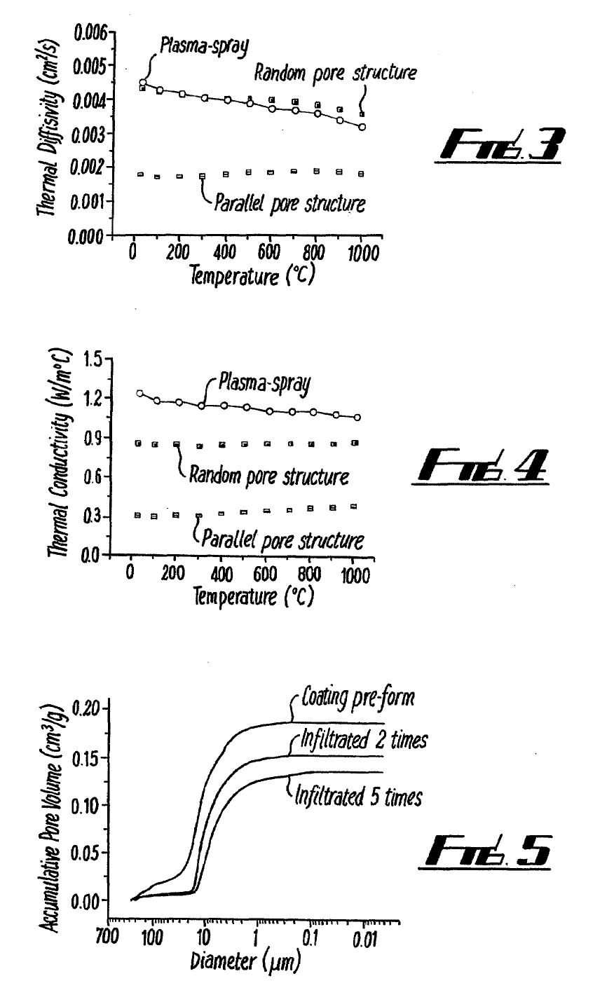

FIG. 3 is a graph showing the thermal diffusivity of a variety of coatings having differing pore structures;

FIG. 4 is a graph showing the thermal conductivity of a variety of coatings according to the present invention, said coatings having differing pore structures;

FIG. 5 is a graph showing the effects of infiltration on the porosity of the coating.

FIG. 1 shows the irregularly shaped pre-formed particles that are typically produced by air-drying.

FIG. 2 shows the plate-like pre-formed particles that are typically produced by EPD coating.

FIG. 3 shows how the porosity of the coating changes the thermal diffusivity of the coating. It can be seen that the coating with random pore structure has a similar thermal diffusivity to that of plasma-sprayed coating, while the coating with parallel pore structure has a much smaller thermal diffusivity. Measured by mercury porosimeter, the plasma sprayed coating was found to have 18% porosity, the coating with random pore structure had 28% porosity, and the coating with parallel pore structure had 30% porosity. Therefore, thermal diffusivity is dependent mainly on pore structure, while porosity does not seem to have an influence on thermal diffusivity.

FIG. 4 shows how the porosity of the coating changes the thermal conductivity of the coating. It can be seen that the coating with random pore structure has a lower thermal conductivity than that of plasma-sprayed coating while the thermal conductivity of the coating with parallel pore structure is only about a quarter of that of plasma sprayed coating. Therefore the thermal conductivity is dependent not only on pore structure, but also on porosity.

FIG. 5 shows how infiltrating the coating changes the porosity of the coating. It can be seen that as more infiltration is carried out on the coating, the less porous the coating is. Also it appears that large pores are the first to be filled by infiltration, indicating that the porosity distribution can be modified by the infiltration operation.

### EXAMPLE 1

An aqueous nano-suspension of ZrO₂ doped with 5.3 wt % Y₂O₃ and 0.25 wt % Al₂O₃ was used as the starting material. The original nano-slurry of 24 wt % in solid load concentration was diluted with distilled water to 3 wt % in solid loading. EPD was employed for the preparation of plate-like pre-formed particles. For EPD, an electrical field of 3-5 volt/cm and deposition time of 2-5 minutes were used. The deposited layer obtained as such was about 5-10 μm in thickness. Upon crushing and sieve classification, plate-like particles of 5˜20 mm in thickness and 50˜250 mm in length were obtained. Further on heat treatment at 1200° C., the plate-like particles were consolidated to dense entities. A paste was prepared by mechanically blending of 5 grams of plate-like particles with 5 grams of nano-slurry for which the solid loading is 53 wt %. The paste was plastered onto Fecralloy substrate. After being dried at room temperature and heat treated at 1200° C. for 1 h in air, coating pre-forms of 100˜500 mm in thickness were obtained with good integrity. The plate-like particles were found to be predominately oriented in parallel to the substrate. The pre-forms were further subjected to infiltration with a nano-slurry of 48 wt % in solid loading, under a pressure of 1 MPa and heat treatment at 800° C. The infiltration and subsequent heat treatment were repeated for twice and finally the coatings were sintered at 1200° C. for 1 h.

### EXAMPLE 2

The same procedure was followed as in sample 1, except that the first time heat treatment was conducted at 500° C. and final sintering was conducted at 1100° C.; and the repetition of the infiltration and heat treatment was five times.

### EXAMPLE 3

The same procedure was followed as in sample 1, except that the stainless steel substrate was used and first time heat treatment was conducted at 500° C., and final sintering was conducted at 900° C. and the repetition of the infiltration and heat treatment was five times.

### EXAMPLE 4

The same procedure was followed as in sample 1, except that the pre-formed particles were in irregular shape which was statistically equiaxed, the size of the preformed particle was 10˜100 mm.

### EXAMPLE 5

An aqueous nano-suspension of ZrO₂ doped with 8 wt % Y₂O₃ was used as the starting material.

The original suspension (23 wt %) was diluted with distilled water to 510 wt % in solid loading.

EPD was employed for the preparation of plate-like preformed particles. For EPD, an electrical field of 5 volt/cm and deposition time of 2˜5 minutes were used. The deposited layer obtained as such was about 5˜10 μm. Upon crushing and sieve classification, plate-like particles of 30˜150 μm in length and 5˜10 μm in thickness were obtained. Further on heat treatment at 1200° C., the plate-like particles were consolidated to dense entities. A paste was prepared by mechanically blending of 3 grams of plate-like particles with 3 grams of nano-slurry for which the solid loading is 57 wt %. The paste was plastered onto Fecralloy substrate. After being dried at room temperature and heat-treated for the first time at 1030° C. for 1 h in vacuum (<10⁻⁵ Torr), coating pre-forms of 100˜500 mm in thickness were obtained with good integrity. The plate-like particles were found to be predominately oriented in parallel to the substrate. The pre-forms were further subjected to infiltrating with a nano-slurry of 40˜60 wt % in solid loading, under a pressure of 1 MPa and heat treatment at 1030° C. in vacuum (<10⁻⁵ Torr). Finally the coatings were sintered at 1200° C. in air for 1 h.

### EXAMPLE 6

The same procedure was followed as in sample 5, except that the first time heat treatment was conducted at 500° C. in air; and the repetition of the infiltration and heat treatment was five times.

### EXAMPLE 7

The same procedure was followed as in sample 5, except that the pre-formed large particles were in randomly irregular shape, the size of the pre-formed particle was 10˜45 mm. For the preparation of the paste, 8 grams of large particles was mixed with 4 grams of nano-slurry for which the solid loading was 57 wt %.

### EXAMPLE 8

The same procedure was followed as in sample 7, except that the size of the pre-formed particle was 10˜75 mm.

### EXAMPLE 9

The same procedure was followed as in sample 7, except that 5 grams of large particles was mixed with 5 grams of nano-slurry for which the solid loading was 57 wt % for the preparation.

### EXAMPLE 10

The same procedure was followed as in sample 7, except that an acetylacetone based ZrO₂ suspension was used for infiltration, which was obtained by attrition milling of ZrO₂ (with 8 wt % Y₂O₃) powder in acetylacetone for 64 hours.

The following examples relate to composite coating materials as herein before described:

### EXAMPLE 11

γ-Al₂O₃ powder and sodium sulfate (Na₂SO₄) were mixed in acetone to form a slurry with a molar ratio (Al₂O₃/Na₂SO₄) of 1:6. Then the mixtures were heat-treated at 1150° C. for 60 min, followed by washing with hydrochloric acid and water. Hexagonal α-Al₂O₃ platelets of ˜8 μm in diagonal distance and ˜2 μm in thickness were obtained as a result.

Aluminum hydroxide was dissolved in phosphate acid at 150° C. with a molar ratio of 1:12 (Al(OH)₃/H₃PO₄) to form a transparent liquid. This liquid was mixed (in a weight ratio of 1:1) with aforementioned hexagonal α-Al₂O₃ particles and applied to titanium alloy substrates using a spatula, followed by heat treatment at 150° C. for 5 hrs first and then at 250° C. for 5 hrs. As a result, α-Al₂O₃/phosphates composite coatings were obtained.

### EXAMPLE 12

The hexagonal α-Al₂O₃ particles as in example i were mixed with a PSZ nano-slurry (as in original sample 5) to form a paste. The paste then was applied to titanium substrates using a spreading method aided by ultrasonic sound (i.e., an ultrasonic probe was used to spread the paste evenly over the surface of the substrates), followed by heat treatment at 300° C. to form a coating preforms.

The coating preforms were further infiltrated with the phosphate liquid as in sample 1, followed by heat treatment followed by heat treatment at 150° C. for 5 hrs first and then at 250° C. for 5 hrs.

### EXAMPLE 13

The same procedure was followed as in example i, except that hexagonal α-Al₂O₃ platelets were prepared using a molar ratio (Al₂O₃/Na₂SO₄) of 1:3.

### EXAMPLE 14

The same procedure was followed as in example ii, except that hexagonal α-Al₂O₃ platelets were prepared using a molar ratio (Al₂O₃/Na₂SO₄) of 1:10.

### EXAMPLE 15

The PSZ preformed particles were prepared using EPD method as in original sample 5. A paste was prepared by mechanically blending of 3 grams of platelike particles with 3 grams of nano-slurry for which the solid loading is 52 wt %. The paste was spread onto titanium substrates aided by ultrasound. After being dried at room temperature and heat-treated at 300° C. As a result coating performs were obtained. The preforms were further subjected to infiltrating with the phosphate liquid under a pressure of 1 MPa and heat treatment at 150° C. for 5 hrs first and then at 250° C. for 5 hrs.

### EXAMPLE 16

The same procedure was followed as in example v, except that the preformed particles were in randomly irregular shape, the size of the pre-formed particle was 10˜45 mm. For the preparation of the paste, 8 grams of large particles was mixed with 4 grams of nano-slurry for which the solid loading was 57 wt %.

It is of course to be understood that the present invention is described by way of example only and is not intended to be restricted to the above examples and embodiments.

1. A green ceramic coating composition comprising nano-sized articles dispersed within a solvent together with pre-formed particles.

2. A coating composition according to claim 1, wherein the nano-sized particles are less than 200 nm in size.

3. A coating composition according to claim 2, wherein the nano-sized particles are less than 100 nm in size.

4. A coating composition according to claim 3, wherein the nano-sized particles have a particle size distribution in the range from 10 nm to 100 nm.

5. A coating composition according to claim 1, wherein the solvent is selected from water or a polar organic solvent.

6. A coating composition according to claim 1, wherein the pre-formed particles have a crystalline nano-structure.

7. A coating composition according to claim 1, wherein the pre-formed particles have a particle size ranging from 5 μm to 300 μm.

8. A coating composition according to claim 7, wherein the pre-formed particles have a particle size ranging from 10 μm to 150 μm.

9. A coating composition according to claim 1, wherein the pre-formed particles form a framework such that at least some of the pre-formed particles contact each other.

10. A coating composition according to claim 1, wherein the pre-formed particles are prepared from a ceramic material selected from any of the following either alone or in combination oxides, borides, silicides, phosphates, sulfides of any of the following boron, aluminium, silicon, titanium, zirconium, hafnium, vanadium, niobium, tantalum, chromium, molybdenum, tungsten, lanthanum, yttrium, iron, cobalt and nickel.

11. A method for producing a ceramic coating upon a substrate, comprising the following steps:
preparing a nano-suspension comprising nano-sized ceramic particles, preparing pre-formed particles,
concentrating the nano-suspension to form a nano-slurry,
mixing the preformed particles with the nano-slurry,
applying the aforesaid mixture to the substrate, and
heat treating the system such that the aforesaid particles produce a ceramic coating.

12. A method according to claim 11, wherein the ratio of pre-formed particles to nano-sized particles is in a range from 1:5 to 1:1 on a dry weight basis.

13. A method according to claim 12, wherein the ratio of pre-formed particles to nano-sized particles is 2:5.

14. A method according to claim 11, wherein the nano-slurry has a solid loading of from 20 to 60 wt %.

15. A method according to claim 11 wherein the nano-slurry is in the form of a paste.

16. A method according to claim 11, wherein the paste comprises any of the following additional ingredients either alone or in combination: water, at least one polar dispersing medium and at least one polymeric surfactant.

17. A method according to claim 16, wherein the polymeric surfactant is selected from polymethacrylic acid (PMAA), poly-methacrylate (PMMA), polyvinyl alcohol and methyl cellulose.

18. A method according to claim 16, wherein the polymeric surfactant constitutes up to about 5% w/w.

19. A method according to claim 11, wherein the coating afforded has a thermal conductivity below 1.0 w/m° C.

20. A method according to claim 11, wherein the coating afforded comprises stable zirconia phases.

21. A method according to claim 11, wherein the green coating is heated at any temperature in the range from 300 to 1200° C.

22. A method according to claim 11, wherein following heat treatment the ceramic coating is infiltrated with an infiltration suspension or slurry.

23. A method according to claim 22, wherein the infiltration process takes place in a pressure chamber at a pressure greater than 1 MPa.

24. A method according to claim 22, wherein the infiltration suspension or slurry exclusively comprises nano-sized particles.

25. A method according to claim 22, wherein the infiltration suspension or slurry comprises a mixture of nano-particles and conventional fine powders.

26. A method according to claim 11 wherein the infiltration media is selected from any of the following either alone or in combination: molten metals, molten salts, metallic particles dispersed within a carrier medium, polymeric materials and inorganic binders.

27. A green composite coating material comprising pre-formed particles dispersed within a solvent together with an infiltration media and/or nano-sized particles.

28. A method for producing a composite coating upon a substrate comprising the steps of:
preparing pre-formed particles,
preparing an infiltration medium,
mixing together said particles and said medium, optionally adding to the mixture a nano-slurry or suspension,
applying the aforesaid mixture to the substrate, and
heat treating the system such that the aforesaid particles become sintered/set thus producing a composite coating.

29. A method of infiltrating a composite coating comprising the steps of:
preparing a substrate having a composite coating as referred to in claim 2,
applying to the said coating an infiltration medium and/or nano-suspension/slurry, and
heat treating the aforesaid infiltrated coating.

30. A method according to claim 22, wherein the infiltration media has a solid loading in the range from 5 to 80 wt %.

31. A method according to claim 22, wherein following infiltration the coating is dried and heat treated at a temperature in the range from 300 to 1200° C.

32. A method for producing a ceramic/metal composite coating upon a substrate comprising the steps of:
preparing pre-formed particles,
preparing a nano-slurry,
mixing together said particles and said slurry,
applying the aforesaid mixture to the substrate,
heat treating the system to produce a partially sintered ceramic porous coating; and
filling the pores and voids in aforesaid ceramic porous coating by employing electrochemical plating and/or electroless deposition with metallic materials, thus forming a ceramic/metal composite coating.

33. A method according to claim 32, wherein the metallic materials are selected from any of the following either alone or in combination: a pure metal such as iron, cobalt, nickel, molybdenum, tungsten, lanthanum, uttrium, vanadium, mobium, tantalum, chromium, boron, aluminium, silicone, titanium, zirconium, hafnium or an alloy thereof.
